(19) United States
(12) Patent Application Publication
(10) Pub. No.: US 2009/0063416 A1
(43) Pub. Date: Mar. 5, 2009

(54) METHODS AND SYSTEMS FOR TAGGING A VARIETY OF APPLICATIONS

(76) Inventors: Norman Lee Faus, Holly Springs, NC (US); Darryl L. Pierce, Apex, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 11/849,233

(22) Filed: Aug. 31, 2007

(51) Int. Cl. G06F 7/06

(52) U.S. Cl. 707/3; 707/E17.14

(57) ABSTRACT

An embodiment pertains generally to a method of tagging for a variety of applications. The method includes providing for a data object, the data object associated with a respective application and applying at least one tag term to the data object. The method also includes creating a context triple for each of the at least one tag term, where a first element of the context triple is the at least one tag term. The method further includes storing the context tag triple in a searchable repository.

### FIELD

This invention relates generally to tagging systems, more particularly, to methods and systems for a tagging system for a variety of applications.

### DESCRIPTION OF THE RELATED ART

The amount of data available to information seekers has grown astronomically, whether as the result of the proliferation of information sources on the Internet, or as a result of private efforts to organize business information within a company, or any of a variety of other causes. As the amount of available data grows, so does the need to be able to categorize or label that data so that the data may be more efficiently searched. One approach is to use tagging for this task.

Tagging is the process of adding or attaching metadata such as descriptive attributes to a data object. A tag may be thought of as a category name. As used herein, a data object may be any type of data (e.g., a website, a text file, an image or a Word document). Operating systems, search mechanisms and filtering mechanisms may utilize tags to organize, sort or filter data objects. A taxonomy or system of classification may be defined by a set of tags and their relationships.

Tagging has become prevalent on the Internet as a means for organizing, and identifying relevant websites, articles and other data objects. Internet services allow users to apply tags to websites, photographic images, articles and the like. Tagging provides users with the ability to classify data objects both for their own use and for use by others. Popular web sites such as Flickr™. and del.icio.us allow users to tag and share photographic images and websites with communities of users.

Tagging is also useful within the context of a single client and allows the user to organize data within the client. For example, a user may store a collection of photographic images on the client. The user may apply the tag “vacation” to photographs taken while on holiday and “graduation” to photographs from graduation day. By sorting the photographs by the tags, the user is able to retrieve the appropriate photographs quickly and efficiently without having to view irrelevant and/or unwanted photographs.

Although tagging can be useful, it is not without disadvantages and drawbacks in a single enterprise or client environment. For example, tags can be applied to many types of data objects within the environment but they can only be utilized by the respective application. More specifically, a tag term, e.g., urban, can be applied to a subset of digital images stored within a file system of the environment. Similarly, a set of word processing files can also be tagged with the tag term “urban”. For a user to retrieve urban tagged digital images and documents, the user can be forced to conduct two searches: one search in the imaging software that organizes the photographs and a second search in the document managing system that manages word processing files. Accordingly, there is a need in the art for a mechanism to allow user to search for all relevant data types across all types of applications in a single search.

### BRIEF DESCRIPTION OF THE DRAWINGS

Various features of the embodiments can be more fully appreciated, as the same become better understood with reference to the following detailed description of an embodiment when considered in connection with the accompanying figures, in which:

FIG. 1 illustrates an exemplary system in accordance with an embodiment;

FIG. 2 illustrates an exemplary block diagram in accordance with another embodiment;

FIG. 3 illustrates an exemplary flow diagram in accordance with yet another embodiment;

FIG. 4 illustrates another exemplary flow diagram in accordance with another embodiment; and

FIG. 5 illustrates an exemplary computer system in accordance with yet another embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of computing systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments relate generally to systems and methods for a tagging engine for a variety of applications. More particularly, the context tagging engine can be configured to apply a tag to data objects that may be any type of data (e.g., a website, a text file, an image or a Word document), each data type having a respective application (browser, electronic mail, spreadsheet, content repository, etc.) While a user has a data object opened in an application, a user can activate a menu icon within the application to activate the context tagging engine. The context tagging engine can display a graphical user interface, e.g., a dialog box, for the user to apply tag terms to the data object. After the user completes tagging the data object, the context tagging engine can save each tag term as a triple. The triple can be considered a data set with three elements: a tag term, an application context, and a link to the data object. Accordingly, for each tag term that a user inputs, the context tagging engine creates a respective triple comprising the tag term, the respective application that opens the data object, and a link to the data object. The context tagging engine can then store the triples in a context tag repository, database or similar device.

Subsequently, the context tagging engine can also comprise a search engine. A user can use the search engine to formulate a query with at least one tag term. The search engine can then return a list of links, where each link points to the data object had been tagged with the at least one tag term. The user can then activate a link to open the data object in its native application.

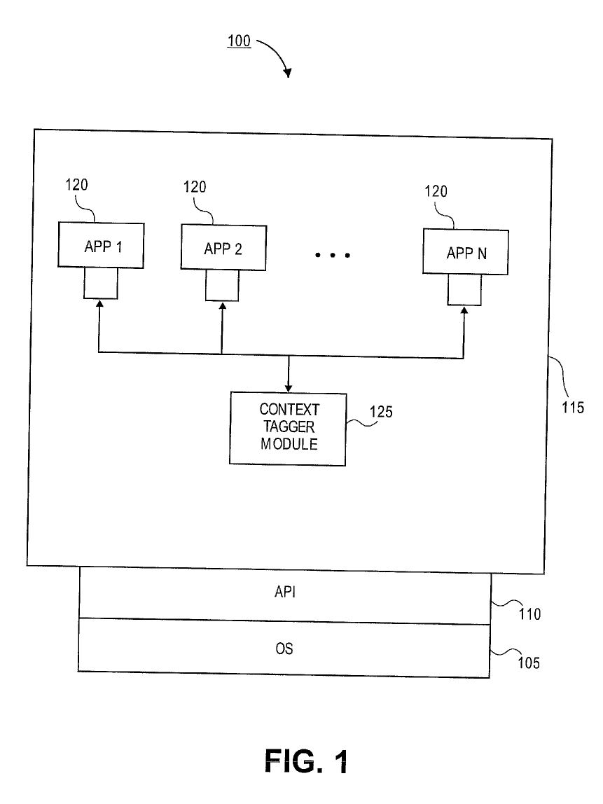

FIG. 1 illustrates an exemplary software environment 100 in accordance with an embodiment. It should be readily apparent to those of ordinary skill in the art that the software environment 100 depicted in FIG. 1 represents a generalized schematic illustration and that other components may be added or existing components may be removed or modified.

As shown in FIG. 1, the software environment 100 may include an operating system 105. The operating system 105 may be a version of a Linux™, UNIX™, Windows™, or similar multi-tasking, multi-user operating system. A run-time environment (not shown) may be configured to execute on the operating system 105. The run-time environment may provide a set of software that supports the execution of applications/programs. The run-time environment may also comprise an application program interface (“API”) 110 and a complementary API (not shown) within an application space 115. The API 110 may be configured to provide a set of routines that the application space 115 uses to request lower-level services performed by the operating system 105. The operating system 105 may include a kernel (not shown). The kernel may be configured to provide secure access to the underlying hardware of a processor.

The application space 115 can represent the space where a user can execute applications given the allotted memory space as determined by a system administrators of the software environment 100. Within the application space 115, a user can open and execute a number of applications 120. The applications that can be executed within the application space 115 can be a wide variety from databases, electronic mail, customer relationship management programs, utilities, browsers, multi-media application, word processing applications, spreadsheet applications, etc. Each of the applications has a native file and/or document format that is associated with the respective application. For example, Microsoft Word™ has default document format, a Word document. Similarly, Adobe™ has a default document type, “pdf” file as another example.

The software environment 100 can further include a context tagging module 125. The context module 125 can be configured to to apply tags (or metadata) to the data objects of the applications 120. While a user has a data object opened in a selected application, a user can activate a menu icon within the selected application to activate the context tagging module 125.

The context tagging module 125 can display a graphical user interface, e.g., a dialog box, for the user to apply tag terms to the data object in response to being invoked. After the user completes tagging the data object, the context tagging module 125 can save each tag term as a triple. The triple can represent a data set with three elements: a tag term, an application context, and a link to the data object. The tag term can be metadata that describes an attribute of the data object. The application context can be the native application that opens the data object. The link to the data object can a hyperlink or a pointer to the physical location of the data object.

Accordingly, for each tag term that a user inputs, the context tagging engine creates a respective triple comprising the tag term, the name of the respective application that operates on the data object, and a link to the data object. The context tagging module 125 can then store the triples in a context tag repository, database or similar device.

Subsequently, the context tagging module 125 can also comprise a search engine. A user can use the search engine to formulate a query with at least one tag term. The search engine can then return a list of links, where each link points to the data object had been tagged with the at least one tag term. The user can then activate a link to open the data object in its native application 120.

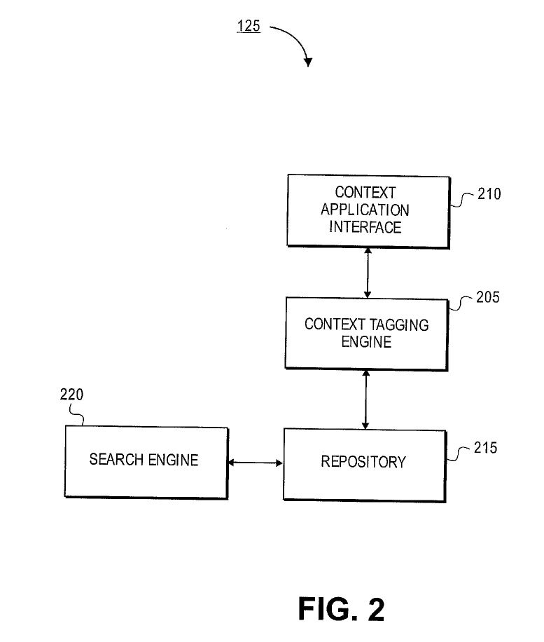

FIG. 2 depicts a more detailed block diagram 200 of the context tagging module 125 in accordance with another embodiment. It should be readily apparent to those of ordinary skill in the art that the diagram depicted in FIG. 2 represents a generalized schematic illustration and that other components may be added or existing components may be removed or modified.

As shown in FIG. 2, the context tagging module 125 can comprise a context tagging engine 205, a context application interface 210, a repository 215, and a search engine 220. The modules 205-220 of the context tagging module 125 can be implemented as software components, hardware components or combinations thereof. More particularly, the module 205-220 can be implemented using conventional programming languages (e.g., Pascal, FORTRAN, etc.), objected oriented programming languages (e.g., C++), Java, PHP, Perl, or other similar languages. The module 205-220 can also be implemented as hardware components such as an application specific integrated circuit, a programmable read-only memory, an EEPROM, a microcontroller, a microprocessor or other similar computing platform.

The context tagging engine 205 can be configured to manage the modules 210-220 to provide the functionality of the context tagging module 125 as previously described and further described herein below. The context tagging engine 205 can be configured, among other things, to receive tag terms applied to a data object from a user and to create a triple for each tag term, where a triple comprises of three elements: a tag term, an application context, and a link to the data object. The context tagging engine 205 can also be configured to store the triples in the repository 215. The context tagging engine 205 can be further generated to graphical user interfaces and/or graphical widgets for a user to interface with the context tagging module 125. For example, the context tagging engine 205 can generate a dialog box for a user to enter tag terms for a data object. In some embodiments, the context tagging module 125 can include a user interface module to generate the appropriate graphical user interfaces.

The context tagging engine 205 can be coupled to the context application interface 210. The context application interface 210 can be configured to provide an interface to the applications 120. More particularly, a menu icon that is linked to the context application interface 210 can be configured to be installed with the application 120. In some instances, the applications 120 can be open source applications, which allow these configuration/installation modifications. If the applications 120 are proprietary applications, i.e., not open source, the applications 120 may permit the same configuration/installation modification depending on their published application program interfaces. When the menu icon is activated, the context application interface 210 can receive the name of the activating application as well as a link to the data object that is opened in the activating application.

The context tagging engine 205 can be further coupled to the repository 215. The repository 215 can be configured to store the triples created by the context tagging engine 205 and to provide a searchable data structure to retrieve previously stored triples. The repository 215 can be implemented as a database using open source technologies, proprietary technologies, or combinations thereof.

The context tagging module 125 can include a search engine 220. The search engine 220 can be an independent module 220 or be part of the repository 215 in some embodiments. The search engine 220 can be configured to receive a query from a user that includes at least one tag term. The search engine 220 can then be configured to search the repository 215 for the triples that include the at least one tag term.

The search engine 220 can then compile a list of matching triples and temporarily buffer the list of matching triples. Subsequently, the search engine 220 can extract the name of the data object from the triples and display the list of matching data objects, each entry on the list displaying the name of the data object as a hyperlink. A user can review the list and activate the link to bring up the data object in its native application. In some embodiments, the user can preview the data object by placing a mouse over the respective entry and bring up a thumbnail image of the data object. Accordingly, a user can bring up matching data objects from every user that contain at least one selected tag term.

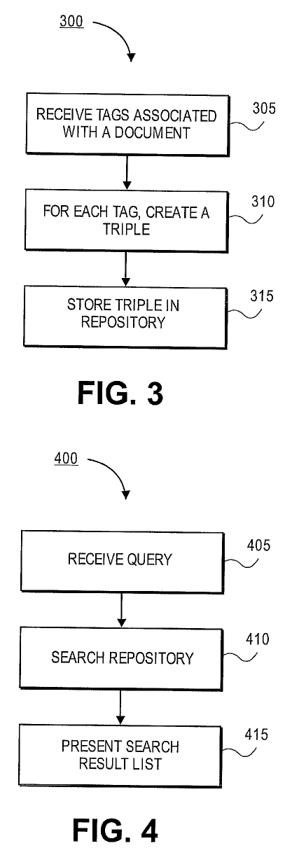

FIG. 3 depicts an exemplary tagging flow diagram 300 implemented by the context tagging engine 205 in accordance with another embodiment. It should be readily apparent to those of ordinary skill in the art that the flow diagram 300 depicted in FIG. 3 represents a generalized schematic illustration and that other steps may be added or existing steps may be removed or modified.

As shown in FIG. 3, the context tagging engine 205 can be configured to receive at least one tag terms associated with a data object, in step 305. More specifically, the context tagging engine 205 can be invoked when a user activates a menu icon within the respective application of the data object. The activate of the menu icon can also forward the name of the respective application as well as a link to the data object to the context tagging engine 205 through the context application interface 210. The name of the respective application and the link can be temporarily buffered by the context tagging engine 205.

The context tagging engine 205 can also generate a graphical user interface to receive the tag terms from the user. For example, the context tagging engine 205 can be configured to generate a dialog box that contains a text entry field for a user to input tag terms.

In step 310, the context tagging engine 205 can be configured to create a triple for each of the received tags from step 305. More particularly, the context tagging engine 205 can retrieve the buffered name of the respective application and the link to the data object and populate a triple with a tag term, the name of the respective application and the link to the data object. A respective triple can then be created for each tag term inputted by the user.

Subsequently, in step 315, the context tagging engine 205 can be configured to store the triple in the repository 215.

FIG. 4 depicts an exemplary tagging flow diagram 400 implemented by the search engine 220 in accordance with another embodiment. It should be readily apparent to those of ordinary skill in the art that the flow diagram 400 depicted in FIG. 4 represents a generalized schematic illustration and that other steps may be added or existing steps may be removed or modified.

As shown in FIG. 4, the search engine 220 can be configured to receive a query from a user in step 405. More specifically, a user can access the search engine 220 of the context tagging module 125 by activating a menu option, command prompt, icon, etc. The search engine 220 can then display a query graphical user interface (“GUI”) for a user to enter tag terms to search for data objects. The query GUI can have a text entry field for users to enter tag terms. In some embodiments, boolean logic can be included in the query GUI to allow for a more focused search with additional search terms. The user can forward the inputted tag terms to the search engine 220 in response to an activation of a submit widget on the query GUI. Subsequently, the search engine 220 can temporarily buffer the query with the selected tag terms.

In step 410, the search engine 220 can be configured to search the repository 215 with the query. The search engine 220 can be configured to temporarily buffer the matching triples.

In step 415, the search engine 220 can then be configured to present the search result list to the user. More specifically, the search engine 220 can extract the name of the data object from the triples and display the list of matching data objects, each entry on the list displaying the name of the data object as a hyperlink. A user can review the list and activate the link to bring up the data object in its native application. In some embodiments, the user can preview the data object by placing a mouse over the respective entry and bring up a thumbnail image of the data object.

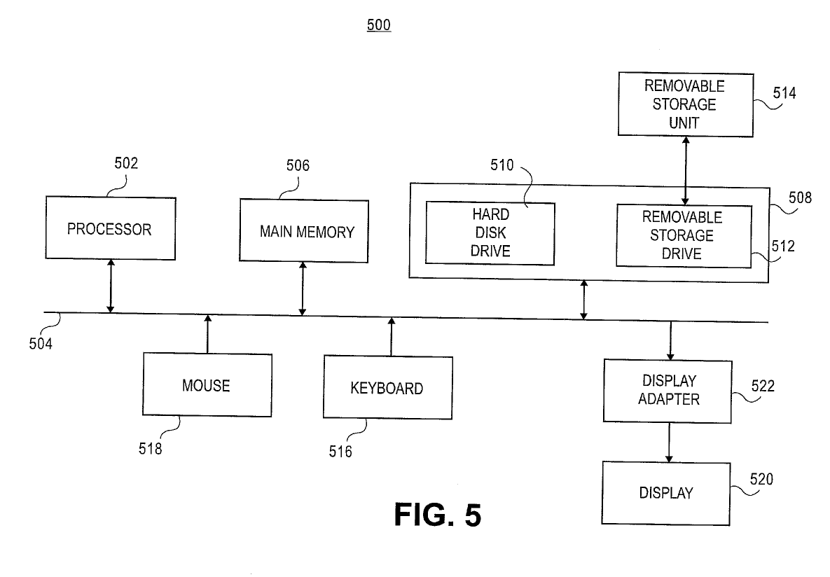

FIG. 5 illustrates an exemplary block diagram of a computing system 500 where an embodiment may be practiced. The functions of the context tagging module 125 may be implemented in program code and executed by the computing platform 500. The context tagging module 125 may be implemented in computer languages such as PASCAL, C, C++, JAVA, etc.

As shown in FIG. 5, the computer system 500 includes one or more processors, such as processor 502 that provide an execution platform for embodiments of the context tagging module 125. Commands and data from the processor 502 are communicated over a communication bus 504. The computer system 500 also includes a main memory 506, such as a Random Access Memory (RAM), where the context tagging module 125 may be executed during runtime, and a secondary memory 508. The secondary memory 508 includes, for example, a hard disk drive 510 and/or a removable storage drive 512, representing a floppy diskette drive, a magnetic tape drive, a compact disk drive, etc., where a copy of a computer program embodiment for the context tagging module 125 may be stored. The removable storage drive 512 reads from and/or writes to a removable storage unit 514 in a well-known manner. A user interfaces with the context tagging module 125 with a keyboard 516, a mouse 518, and a display 520. The display adapter 522 interfaces with the communication bus 504 and the display 520. The display adapter 522 also receives display data from the processor 502 and converts the display data into display commands for the display 520.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of tagging for a variety of applications, the method comprising:
providing for a data object, the data object associated with a respective application;
applying at least one tag term to the data object;
creating a context triple for each of the at least one tag term, wherein a first element of the context triple is the at least one tag term; and
storing the context tag triple in a searchable repository.

2. The method of claim 1, wherein the creating the context triple further comprising populating a second element of the context triple with a name of the respective application.

3. The method of claim 2, further comprising populating a third element of the context triple with a link to the data object.

4. The method of claim 3, further comprising:
accumulating a plurality of context triples, the plurality of context triples based on a plurality of applications;
searching the plurality of context triples based on a selected tag term.

5. The method of claim 4, further comprising:
developing a subset of the plurality of context triples, each context triple of the subset of the plurality of context triples having the selected tag term as an element; and
assembling a search result list based on the subset of the plurality of context triples, wherein each entry on the search result list further comprises the link to a respective data object and its associated native application.

6. The method of claim 5, further comprising:
activating the link to a selected entry on the search result list;
invoking the associated native application with the respective data object opened therein.

7. An apparatus for tagging a variety of data objects, the apparatus comprising:
an application interface configured to couple with a plurality of applications;
a context repository; and
a tagging engine configured to couple with the application interface and the context repository, wherein the tagging engine is configured to apply at least one tag term to a data object in response to being invoked within a native application of the data object; to create a context triple for each of the at least one tag term, wherein one element of the context triple is the at least one tag term; and to store the context tag triple in context repository.

8. The apparatus of claim 7, wherein the tagging engine is further configured to create the context triple further comprising populating a second element of the context triple with a name of the native application.

9. The apparatus of claim 8, wherein the tagging engine is further configured to populate a third element of the context triple with a link to the data object.

10. The apparatus of claim 9, wherein the context repository is further configured to accumulate a plurality of context triples, the plurality of context triples based on a plurality of applications.

11. The apparatus of claim 10, further comprising a search engine coupled to the context repository, the search engine configured to search the context repository based on at least one search tag term in a query.

12. The apparatus of claim 11, wherein the search engine is further configured to develop a subset of the plurality of context triples, each context triple of the subset of the plurality of context triples having the selected tag term as an element; and to assemble a search result list based on the subset of the plurality of context triples, wherein each entry on the search result list further comprises a link to a respective data object and its associated native application.

13. The apparatus of claim 12, wherein the search result list is further configured to invoke the associated native application with the respective data object in response to activating a respective link.

14. A system for tagging a variety of data objects, the system comprising:
a server configured to store and execute a plurality of applications for a plurality of users, wherein each user is configured to be assigned a respective application space to execute the plurality of applications and each application of the plurality having a respective data object type;
a context repository configured to be accessible to the plurality of users; and
a context tagging module configured to execute in the application space and to couple with each application of the plurality of applications, wherein the context tagging module is configured to apply at least one tag term to a data object in response to being invoked within the respective application; to create a context triple for each of the at least one tag term, wherein a first element of the context triple is the at least one tag term; and to store the context tag triple in the context repository.

15. The system of claim 14, wherein the context tagging module is further configured to create the context triple further comprising populating a second element of the context triple with a name of the respective application.

16. The system of claim 15, wherein the context tagging module is further configured to populate a third element of the context triple with a link to the data object.

17. The system of claim 16, wherein the context repository is further configured to accumulate a plurality of context triples, the plurality of context triples based on a plurality of applications.

18. The system of claim 17, further comprising a search engine coupled to the context repository, the search engine configured to search the context repository based on at least one search tag term in a query.

19. The system of claim 11, wherein the search engine is further configured to develop a subset of the plurality of context triples, each context triple of the subset of the plurality of context triples having the selected tag term as an element; and to assemble a search result list based on the subset of the plurality of context triples, wherein each entry on the search result list further comprises a link to a respective data object and its associated respective application.

20. The system of claim 19, wherein the search result list is further configured to invoke the associated native application with the respective data object in response to activating a respective link.
